(19) United States
(12) Patent Application Publication
(10) Pub. No.: US 2026/0307402 A1
(43) Pub. Date: Oct. 8, 2026

(54) PRINTER

(71) Applicant: Roland DG Corporation, Hamamatsu-shi (JP)

(72) Inventors: Takayuki MORIKAMI, Hamamatsu-shi (JP); Shinya YAMAMOTO, Hamamatsu-shi (JP)

(21) Appl. No.: 19/637,045

(22) Filed: Apr. 2, 2026

(30) Foreign Application Priority Data
Apr. 4, 2025 (JP) 2025-062470

(51) Int. Cl. B41J 11/00; B41J 15/04; B41J 15/16

(52) U.S. Cl. CPC B41J 11/0095; B41J 15/046; B41J 15/048; B41J 15/16

(57) ABSTRACT

A printer includes a support table to support a medium, a winder to wind up the medium, and a controller. The winder includes a windup bar having the medium wound therearound, a windup motor to rotate the windup bar, and an encoder to detect rotation of the windup bar. The controller is configured or programmed to include a windup instructor to issue a windup instruction to wind up the medium around the windup bar, a rotation detector to detect presence/absence of the rotation of the windup bar, a detector to detect a medium tensile force of the medium, and an abnormality determiner to determine presence/absence of a windup abnormality and to determine the presence/absence of the windup abnormality based on presence/absence of the windup instruction, the presence/absence of the rotation of the windup bar, and a magnitude of the medium tensile force.

### CROSS REFERENCE TO RELATED APPLICATION

This application claims the benefit of priority to Japanese Patent Application No. 2025-62470 filed on Apr. 4, 2025. The entire contents of this application are hereby incorporated by reference herein.

### BACKGROUND OF THE INVENTION

### 1. Field of the Invention

The present invention relates to printers.

### 2. Description of the Related Art

For example, Japanese Laid-Open Patent Publication No. 2019-147361 discloses a printing device determining a state of slip of a printing medium. The printing device includes a feeding portion that includes a roll support shaft having a printing medium wound therearound and feeds the printing medium, a transportation portion including a guide roller transporting the printing medium fed by the feeding portion, and a windup portion including a windup shaft winding up the printing medium transported by the transportation portion.

The roll support shaft includes a first encoder. The guide roller includes a second encoder. This printing device determines whether or not the printing medium is slipping, based on a pulse signal output from the first encoder and a pulse signal output from the second encoder.

In the above-described printing device, an abnormality may possibly occur to the windup portion. The above-described printing device cannot detect such an abnormality occurring to the windup portion. There is an undesirable possibility that when an abnormality occurs to the windup portion, the printing medium transported by the transportation portion is not wound up around the windup shaft of the windup portion.

### SUMMARY OF THE INVENTION

Example embodiments of the present invention provide printers each capable of determining presence/absence of a windup abnormality while a medium is wound up.

A printer according to an example embodiment of the present invention includes a support table to support a medium, a transporter to transport the medium supported by the support table in a transportation direction, a winder to wind up the medium transported downstream with respect to the support table in the transportation direction, and a controller. The winder includes a windup bar to wind up the medium around a circumferential surface thereof, a windup motor to rotate the windup bar around a central axis of the windup bar, and an encoder to detect the rotation of the windup bar. The controller is configured or programmed to include a windup instructor, a rotation detector, a detector, and an abnormality determiner. The windup instructor is configured or programmed to issue a windup instruction to rotate the windup bar and wind up the medium around the windup bar. The rotation detector is configured or programmed to detect presence/absence of the rotation of the windup bar by use of the encoder. The detector is configured or programmed to detect a medium tensile force of the medium between the support table and the winder. The abnormality determiner is configured or programmed to determine presence/absence of a windup abnormality while the medium is wound up around the windup bar. The abnormality determiner is configured or programmed to determine the presence/absence of the windup abnormality based on presence/absence of the windup instruction by the windup instructor, the presence/absence of the rotation, of the windup bar, detected by the rotation detector, and a magnitude of the medium tensile force detected by the detector.

According to the above-described printer, for example, when the windup instruction is issued in the case where the winder is normal, the windup bar is rotated to gradually increase the medium tensile force. After this, the rotation of the windup bar is stopped. If, for example, the windup instruction is not issued in the case where the winder is normal, the windup bar is not rotated. Therefore, the presence/absence of a windup abnormality may be determined based on the presence/absence of the rotation of the windup bar and the magnitude of the medium tensile force in accordance with the presence/absence of the windup instruction.

According to example embodiments of the present invention, printers each capable of determining presence/absence of a windup abnormality while a medium is wound up are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a front view of a printer according to an example embodiment of the present invention.

FIG. 2 is a cross-sectional view of the printer taken along line II-II in FIG. 1.

FIG. 3 is a bottom view schematically showing configurations of bottom surfaces of a carriage and ink heads.

FIG. 4 is a block diagram of the printer according to an example embodiment of the present invention.

FIG. 5 is a table showing the relationship between presence/absence of a windup abnormality and a combination of presence/absence of a windup instruction, presence/absence of detection of a rotation of a windup bar and a magnitude of a medium tensile force.

FIG. 6 is a flowchart showing a procedure of determining presence/absence of a windup abnormality during transportation of a medium.

### DETAILED DESCRIPTION OF THE EXAMPLE EMBODIMENTS

Hereinafter, example embodiments of the present invention will be described with reference to the drawings. Example embodiments described herein are not intended to limit the present invention. Components and portions having the same functions will bear the same reference signs, and overlapping descriptions will be omitted or simplified when appropriate.

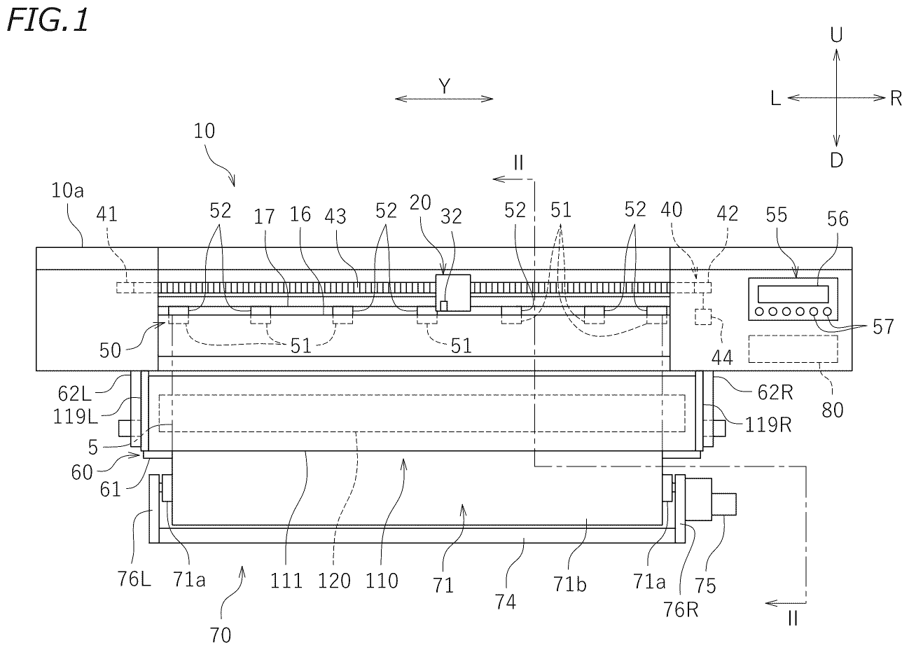

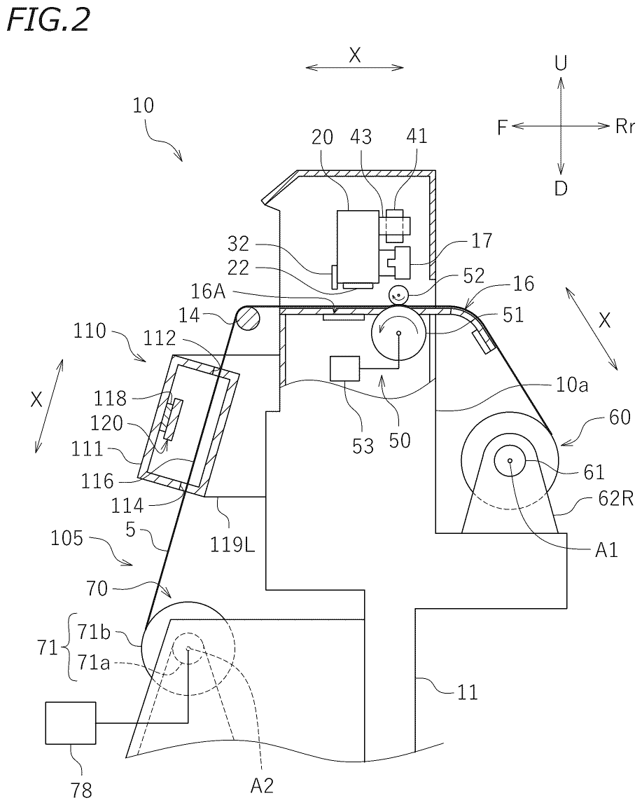

FIG. 1 is a front view of a printer 10 according to this example embodiment. FIG. 2 is a cross-sectional view of the printer 10 taken along line II-II in FIG. 1. In the following description on the printer 10, terms “left”, “right”, “up” and “down” will respectively refer to left, right, up and down as seen from a user facing a front surface of the printer 10. A direction from the printer 10 toward the user will be referred to as “forward”, and a direction from the user toward the printer 10 will be referred to as “rearward”. In the drawings, letters F, Rr, L, R, U and D respectively represent front, rear, left, right, up and down for the printer 10. In the drawings, letter Y represents a main scanning direction. In this example embodiment, the main scanning direction Y is a left-right direction. In the drawings, letter X represents a sub scanning direction. In this example embodiment, the sub scanning direction X is a direction crossing (in this example embodiment, perpendicularly crossing) the main scanning direction Y as seen in a plan view. In this example embodiment, the sub scanning direction X is a front-rear direction as seen in a plan view. The sub scanning direction X is the front-rear direction on a support table 16 (see FIG. 2) described below. The sub scanning direction X is an example of transportation direction. In this example embodiment, a rear side in the sub scanning direction X will be referred to as an “upstream side”, and a front side in the sub scanning direction X will be referred to as a “downstream side”. Note that these directions are merely defined for the sake of convenience, and do not limit the manner of installation of the printer 10 or do not limit the present invention either.

The printer 10 is a printer of an inkjet system, and is a so-called inkjet printer. Note that the printer 10 is not limited to a printer of an inkjet system, and may be, for example, a printer of a thermal system or a printer of a laser system. In this example embodiment, the printer 10 is a roll-to-roll type printer, which moves a medium 5 in the sub scanning direction X while unrolling the medium 5 on the support table 16 (see FIG. 2).

In this example embodiment, the printer 10 performs printing on the medium 5, which is of a roll-type. Herein, “printing on the medium 5” refers to, in a state where the roll-type medium 5 is unrolled, performing printing on an unrolled portion of the medium 5. The medium 5 is, in a state of being set on the printer 10, rolled around a rotation axis A1 (see FIG. 2) extending in the main scanning direction Y. The medium 5 has such a shape as to be allowed to be wound up around a windup bar 71 (see FIG. 2) of a winder 70 described below. The printer 10 performs printing while the medium 5 is in a pulled-out state, that is, in an unrolled state.

In this example embodiment, the medium 5 is bulged by being heated. In this example embodiment, the medium 5 is bulged by a portion thereof heated at a predetermined heating temperature being foamed. The medium 5 includes a base portion formed of, for example, film or the like and a thermally foamable layer formed of a thermally expandable microcapsule applied on the base portion. A heated portion of the thermally foamable layer of the medium 5 is foamed, so that the heated portion of the medium 5 is bulged. In this manner, a printed item including convex and concave portions is produced.

As shown in FIG. 2, the printer 10 includes a printer body 10a and a leg 11. As shown in FIG. 1, the printer body 10a includes a casing extending in the main scanning direction Y. As shown in FIG. 2, the leg 11 supports the printer body 10a. The leg 11 is provided on a bottom surface of the printer body 10a, and extends downward from the printer body 10a.

The printer 10 includes the support table 16 and a support roller 14. The support table 16 and the support roller 14 support the medium 5. In this example embodiment, the support table 16 and the support roller 14 support the roll-type medium 5 in a state where the medium 5 is unrolled. In the following description, the term “medium 5” encompasses the roll-type medium 5 in an unrolled state. The medium 5 is placed on the support table 16 in an unrolled state. Printing on the medium 5 is performed on the support table 16. The support table 16 is a so-called platen. In this example embodiment, a top surface of the support table 16 extends in the main scanning direction Y and the sub scanning direction X. An upstream-side portion of the support table 16 (in this example embodiment, a rear portion thereof) is formed to have an arc-shaped vertical cross-section and is curved downward while extending rearward.

The support roller 14 is a roller extending in the main scanning direction Y. In this example embodiment, the support roller 14 is supported by the printer body 10a so as to be rotatable with respect to the printer body 10a, although such a state is not shown. The support roller 14 is located downstream with respect to the support table 16 in the sub scanning direction X. In this example embodiment, the support roller 14 is located to the front of the support table 16. The medium 5 is transported from the support table 16 toward a circumferential surface of the support roller 14. Along with the transportation of the medium 5, the support roller 14 rotates. The support roller 14 is rotated, and as a result, a portion of the medium 5 that is supported by the support roller 14 is transported downstream in the sub scanning direction X. FIG. 1 does not show the support roller 14.

The printer 10 includes a guide rail 17, a carriage 20, and ink heads 22 (see FIG. 2). The guide rail 17 is located above the support table 16. As shown in FIG. 1, the guide rail 17 is located parallel to the top surface of the support table 16 and extends in the main scanning direction Y. The guide rail 17 is in engagement with the carriage 20. The carriage 20 is provided to be slidable along the guide rail 17 and is configured to be movable in the main scanning direction Y.

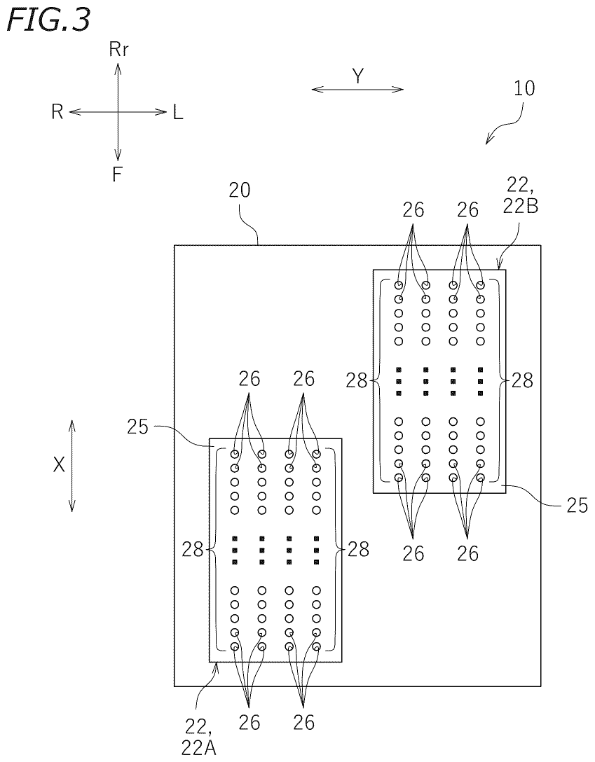

As shown in FIG. 2, the ink heads 22 eject ink. The ink heads 22 are provided on the carriage 20. The ink heads 22 are supported by the carriage 20 such that bottom surfaces thereof are exposed downward. There is no specific limitation on the number of the ink heads 22. The number of the ink heads 22 may be one, or may be greater than one. FIG. 3 is a bottom view schematically showing configurations of bottom surfaces of the carriage 20 and the ink heads 22. In this example embodiment, as shown in FIG. 3, there are two ink heads 22, for example. The two ink heads 22 are lined up in the main scanning direction Y. The ink heads 22 each include a nozzle surface 25. The nozzle surface 25 is the bottom surface of the corresponding ink head 22. Each nozzle surface 25 includes nozzles 26 to eject ink. A plurality of the nozzles 26 are lined up in the sub scanning direction X. In this example embodiment, a column of a plurality of nozzles 26 lined up in the sub scanning direction X will be referred to as a “nozzle column 28”. Four nozzle columns 28 are provided in one ink head 22, for example. Note that there is no specific limitation on the number of the nozzle columns 28 provided in one ink head 22. The number of the nozzle columns 28 in one ink head 22 may be 1, 2 or 3, or may be 5 or greater.

In this example embodiment, as shown in FIG. 3, one of the two ink heads 22 is a foaming-suppressing ink head 22A, and the other of the two ink heads 22 is a color ink head 22B. The ink heads 22 include the foaming-suppressing ink head 22A and the color ink head 22B. In this example embodiment, the foaming-suppressing ink head 22A and the color ink head 22B are located at different positions from each other in the sub scanning direction X, and are located in a so-called staggered arrangement. In this example embodiment, the foaming-suppressing ink head 22A is located to protrude forward with respect to the color ink head 22B.

The foaming-suppressing ink head 22A (more specifically, the nozzles 26 of the foaming-suppressing ink head 22A) ejects foaming-suppressing ink suppressing foaming of the medium 5 (more specifically, the thermally foamable layer of the medium 5) even if the medium 5 is heated. The foaming-suppressing ink is ejected toward a portion of the medium 5 that is to be prevented from being foamed even if being heated and thus is to be prevented from being bulged. The remaining portion of the medium 5, that is, a portion toward which the foaming-suppressing ink is not ejected, is heated and foaming of the remaining portion is promoted. As a result, the portion, of the medium 5, toward which the foaming-suppressing ink is not ejected is heated and foamed to be bulged. In this example embodiment, the foaming-suppressing ink is transparent (in other words, colorless). Alternatively, the foaming-suppressing ink may be colored.

The color ink head 22B (more specifically, the nozzles 26 of the color ink head 22B) ejects color ink. An image is formed on the medium 5 with the color ink ejected from the color ink head 22B. The color ink ejected from the color ink head 22B is, for example, one color of ink among a plurality of colors of process color ink and a plurality of colors of spot color ink. The process color ink includes, for example, cyan ink, magenta ink, yellow ink, black ink and the like. The spot color ink includes ink of colors other than the colors of the process color ink. The spot color ink includes, for example, white ink, clear ink, gloss ink, primer ink, fluorescent ink, metallic ink, orange ink, red ink, violet ink, blue ink, green ink and the like. In this example embodiment, each of the nozzle columns 28 of the color ink head 22B ejects one of the color ink. There is no specific limitation on the material of the color ink. Any of various materials conventionally used as materials of the ink for inkjet printers or the like is usable. The color ink may be, for example, solvent-based pigment ink or aqueous pigment ink. Unlike the above-described foaming-suppressing ink, the color ink does not suppress foaming even if a portion, of the medium 5, toward which the color ink is ejected is heated.

As shown in FIG. 2, the printer 10 includes a sheet cutter 32. The sheet cutter 32 cuts the medium 5 in an unrolled state that is supported by the support table 16. In this example embodiment, the sheet cutter 32 is used to cut the medium 5 linearly along the main scanning direction Y. The medium 5 cut by the sheet cutter 32 is divided into two, that is, into an upstream-side portion (in this example embodiment, a rear portion) in the sub scanning direction X and a downstream-side portion (in this example embodiment, a front portion) in the sub scanning direction X. FIG. 3 does not show the sheet cutter 32. In this example embodiment, as shown in FIG. 2, the sheet cutter 32 is provided on the carriage 20. The sheet cutter 32 is configured to be movable in an up-down direction with respect to the carriage 20.

In this example embodiment, as shown in FIG. 2, the top surface of the support table 16 includes a cutter groove 16A, formed therein, extending in the main scanning direction Y. As seen in a plan view, the sheet cutter 32 is located at a position overlapping the cutter groove 16A in the sub scanning direction X. The sheet cutter 32 is configured to, when cutting the medium 5, pass through the medium 5 and go into the cutter groove 16A.

As shown in FIG. 1, the printer 10 includes a head moving mechanism 40 and a transporter 50. The head moving mechanism 40 moves the medium 5 supported by the support table 16 and the carriage 20/the ink heads 22/the sheet cutter 32 in the main scanning direction Y with respect to each other. In this example embodiment, the head moving mechanism 40 moves the carriage 20, the ink heads 22 and the sheet cutter 32 in the main scanning direction Y. There is no specific limitation on the configuration of the head moving mechanism 40.

In this example embodiment, the head moving mechanism 40 includes a pulley 41, a pulley 42, an endless belt 43 and a scan motor 44. The pulley 41 is provided in the vicinity of a left end of the guide rail 17. The pulley 42 is provided in the vicinity of a right end of the guide rail 17. The belt 43 is wound between the pulley 41 and the pulley 42. As shown in FIG. 2, the belt 43 is secured to a top portion of a rear surface of the carriage 20. As shown in FIG. 1, the scan motor 44 is connected with the right pulley 42. Note that the scan motor 44 may be connected with the left pulley 41. In this example embodiment, the scan motor 44 is driven to rotate the pulley 42, so that the belt 43 runs between the pulley 41 and the pulley 42. As a result, the carriage 20, the ink heads 22 and the sheet cutter 32 move in the main scanning direction Y.

The transporter 50 transports the medium 5 and the ink heads 22 in the sub scanning direction X with respect to each other. In this example embodiment, the transporter 50 transports an unrolled portion of the roll-type medium 5, that is, a portion thereof supported by the support table 16, in the sub scanning direction X. There is no specific limitation on the configuration of the transporter 50.

In this example embodiment, as shown in FIG. 2, the transporter 50 includes grit rollers 51 (only one is shown in FIG. 2), pinch rollers 52 (only one is shown in FIG. 2) and a feed motor 53. The grit rollers 51 are provided in the support table 16. In this example embodiment, the grit rollers 51 are buried in the support table 16 so as to be at least partially exposed on the support table 16. During the transportation of the medium 5, the grit rollers 51 contact the medium 5. The pinch rollers 52 press, from above, an unrolled portion of the roll-type medium 5, and are located above the grit rollers 51. The pinch rollers 52 sandwich the medium 5 together with the grit rollers 51. The pinch rollers 52 face the grit rollers 51. The pinch rollers 52 are configured to be movable in the up-down direction. There is no specific limitation on the positions or the number of the grit rollers 51 or the pinch rollers 52. In this example embodiment, as shown in FIG. 1, seven grit rollers 51 and seven pinch rollers 52 are provided, for example. The plurality of grit rollers 51 are lined up in the main scanning direction Y, and the plurality of pinch rollers 52 are lined up in the main scanning direction Y. In this example embodiment, as shown in FIG. 2, the feed motor 53 is connected with one of the grit rollers 51. The feed motor 53 rotates the grit rollers 51. When the feed motor 53 is driven to rotate the grit rollers 51 in a state where the medium 5 is sandwiched between the grit rollers 51 and the pinch rollers 52, the unrolled portion of the roll-type medium 5 is transported in the sub scanning direction X (e.g., downstream in the sub scanning direction X).

As shown in FIG. 2, the printer 10 includes a feeding device (feeder) 60 including a feeding bar 61. The medium 5 in a rolled state is detachably attached to the feeding device 60. The feeding device 60 feeds the roll-type medium 5 in an unrolled state to the support table 16. The feeding bar 61 is located to the rear of, and below, the support table 16. As shown in FIG. 1, the feeding bar 61 has a tubular shape having a circular cross-section, or a cylindrical shape, extending in the main scanning direction Y. The medium 5 is wound around a circumferential surface of the feeding bar 61 before printing is performed. A left end of the feeding bar 61 is rotatably supported by a left guide plate 62L, and a right end of the feeding bar 61 is rotatably supported by a right guide plate 62R. The transporter 50 transports the medium 5 in an unrolled state downstream in the sub scanning direction X, so that the unrolled portion of the roll-type medium 5 is fed out toward the support table 16 from the feeding bar 61. In this example embodiment, the printer 10 does not include a motor rotating the feeding bar 61. Alternatively, the printer 10 may include such a motor.

As shown in FIG. 2, the printer 10 includes a winder 70 winding up the medium 5 in an unrolled state, supported by the support table 16, into a roll shape. The winder 70 winds up the medium 5 transported downstream with respect to the support table 16 in the sub scanning direction X. The winder 70 includes the windup bar 71, a windup motor 75 (see FIG. 1) and an encoder 78.

The windup bar 71 winds up the medium 5 in an unrolled state. As shown in FIG. 1, the windup bar 71 has a tubular shape having a circular cross-section, or a cylindrical shape, extending in the main scanning direction Y. As shown in FIG. 2, the windup bar 71 is located below the support table 16 and below the feeding bar 61. The windup bar 71 is located below the support roller 14. The windup bar 71 is rotatable around a central axis A2 extending in the main scanning direction Y. As shown in FIG. 1, the printer 10 includes a first left side wall 76L and a first right side wall 76R supporting the windup bar 71 such that the windup bar 71 is rotatable. The windup bar 71 includes a support portion 71a supported by the first left side wall 76L and the first right side wall 76R and also includes a tubular portion 71b having a diameter larger than that of the support portion 71a. The roll-type medium 5 is wound up around a circumferential surface of the tubular portion 71b. The support portion 71a and the tubular portion 71b may be formed integrally with each other, or may be formed separately from each other. A left end of the windup bar 71 is rotatably supported by the first left side wall 76L. A right end of the windup bar 71 is rotatably supported by the first right side wall 76R. The printer 10 includes a rail 74 supporting the first left side wall 76L and the first right side wall 76R. The rail 74 extends in the main scanning direction Y.

The windup motor 75 is connected with the windup bar 71, and rotates the windup bar 71 around the central axis A2 of the windup bar 71. The windup motor 75 is indirectly connected with the windup bar 71 via a deceleration gear or the like (not shown). The windup bar 71 rotates upon receipt of a driving force of the windup motor 75. In this example embodiment, when the windup motor 75 rotates, a portion of the medium 5 that is supported by the support table 16 is transported downstream in the sub scanning direction X toward the support roller 14. The medium 5 is then transported from the support roller 14 toward the windup bar 71, and is wound up around the circumferential surface of the tubular portion 71b of the windup bar 71.

The encoder 78 detects the rotation of the windup bar 71. The encoder 78 detects the rotation rate or the rotation angle of the windup bar 71 to detect whether or not the windup bar 71 is rotated. For example, when the windup motor 75 of the winder 70 is driven, the driving force of the windup motor 75 is transmitted to the windup bar 71, so that the encoder 78 detects that the windup 71 is rotated. In this example embodiment, the encoder 78 detects the rotation of the windup bar 71 and thus detects that the medium 5 has been wound up around the circumferential surface of the windup bar 71. There is no specific limitation on the detection method of the encoder 78. The encoder 78 may be an optical encoder or a magnetic encoder.

In this example embodiment, in the case where the medium 5 is transported from the feeding device 60 toward the support table 16, the sub scanning direction X is inclined upward while extending forward from the rear side. In the case where the medium 5 is transported from the support roller 14 toward the windup bar 71, the sub scanning direction X is inclined downward while extending forward from the rear side.

In this example embodiment, as shown in FIG. 1, the printer 10 includes an operation panel 55 provided at a right end of the printer body 10a. The operation panel 55 includes a display screen 56 to display, for example, the state of the printer 10, operation keys 57 operable by the user, and the like.

In this example embodiment, in order that the medium 5 is partially bulged, more specifically, in order that a portion, of the medium 5, toward which the foaming-suppressing ink mentioned above is not ejected is foamed and bulged, the medium 5 is heated. For this purpose, in this example embodiment, as shown in FIG. 2, the printer 10 includes a heating device 110 to heat the medium 5. The heating device 110 heats a portion of the medium 5 that is transported downstream in the sub scanning direction X from the support table 16 and the support roller 14. The heating device 110 is located downstream with respect to the support table 16 and the support roller 14 in the sub scanning direction X. In this example embodiment, the heating device 110 is located to the front of the support table 16. The heating device 110 is located below the support roller 14 and above the winder 70. In this example embodiment, the heating device 110 is located on a transportation route 105, along which the medium 5 is transported from the support roller 14 toward the winder 70.

As shown in FIG. 2, the heating device 110 includes a heating device body 111 and a heater 120. The heating device body 111 is a case-shaped body having a space therein. As shown in FIG. 1, the heating device body 111 extends in the main scanning direction Y. As shown in FIG. 2, the heating device body 111 is located in the middle of the transportation route 105.

In this example embodiment, as shown in FIG. 1, the heating device 110 includes a left securing member 119L and a right securing member 119R to secure the heating device body 111 to the printer body 10a. The left securing member 119L and the right securing member 119R are plate-shaped structures secured to the printer body 10a. The left securing member 119L and the right securing member 119R are lined up in the main scanning direction Y, and face each other. In this example embodiment, a left end of the heating device body 111 is provided on the left securing member 119L. A right end of the heating device body 111 is provided on the right securing member 119R. The heating device body 111 is secured to the printer body 10a via the left securing member 119L and the right securing member 119R.

In this example embodiment, as shown in FIG. 2, the heating device body 111 includes a medium entrance 112 and a medium exit 114 formed therein. In this example embodiment, the medium 5 is heated in the heating device body 111 of the heating device 110. The medium 5 passes through the medium entrance 112 and the medium exit 114. A portion of the medium 5 that is transported from the support roller 14 passes through the medium entrance 112 to be transported to the inside of the heating device body 111. A portion of the medium 5 that is inside the heating device body 111 passes through the medium exit 114 to be transported to the outside of the heating device body 111. In this example embodiment, the medium entrance 112 is located in a top surface of the heating device body 111, and extends in the main scanning direction Y. The medium exit 114 is located in a bottom surface of the heating device body 111, and extends in the main scanning direction Y. The medium exit 114 is located below the medium entrance 112.

In this example embodiment, a heating support plane 116 is provided in the heating device body 111. The heating support plane 116 couples the medium entrance 112 and the medium exit 114 to each other. In this example embodiment, the heating support plane 116 extends in the main scanning direction Y and in the up-down direction. More specifically, the heating support plane 116 extends obliquely from the medium entrance 112 to the medium exit 114. In this example embodiment, a portion of the medium 5 that has passed through the medium entrance 112 is supported by the heating support plane 116 in the heating device body 111. A portion of the medium 5 that is supported by the heating support plane 116 passes through the medium exit 114 and is transported to an area below the heating device 110.

The heater 120 is located in the heating device body 111 and is secured to the heating device body 111. In this example embodiment, the heater 120 is attached to an attachment member 118 provided in the heating device body 111. The heater 120 is configured to heat the inside of the heating device body 111, and thus to heat a portion of the medium 5 that is transported to the inside of the heating device body 111. In this example embodiment, the heater 120 heats a portion of the medium 5 that is supported by the heating support plane 116 located in the heating device body 111. As shown in FIG. 1, the heater 120 extends in the main scanning direction Y. There is no specific limitation on the type of the heater 120. The heater 120 is, for example, a ceramic heater.

As shown in FIG. 1, the printer 10 includes a controller 80. The controller 80 is configured or programmed to perform controls on printing and the like. There is no specific limitation on the configuration of the controller 80. The controller 80 may be, for example, a microcomputer. There is no specific limitation on the hardware configuration of the microcomputer. The controller 80 may be configured or programmed to include, for example, an I/F, a CPU, a ROM, a RAM, and a storage device. The controller 80 is provided in the printer body 10a. Note that the controller 80 may not be provided in the printer body 10a. For example, the controller 80 may be a computer or the like provided outside the printer body 10a. In this case, the controller 80 is communicably connected with a control board (not shown) of the printer 10 in a wired or wireless manner.

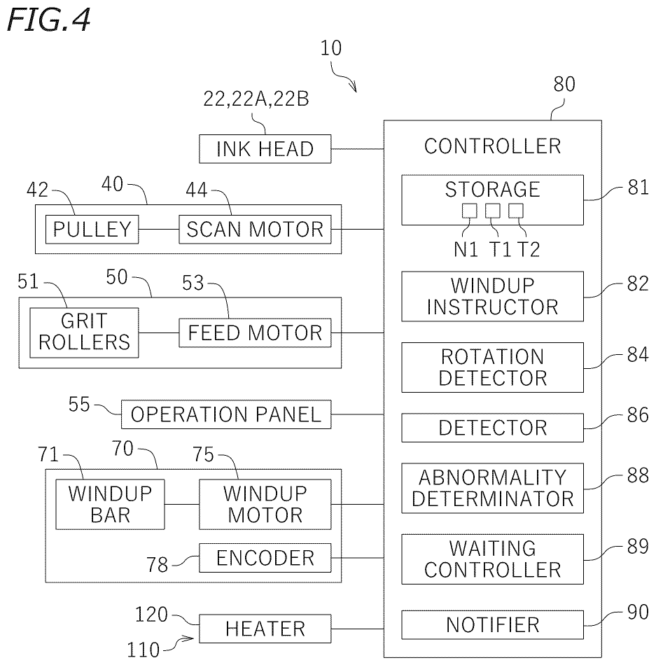

FIG. 4 is a block diagram of the printer 10 according to this example embodiment. In this example embodiment, as shown in FIG. 4, the controller 80 is communicably connected with the ink heads 22, the head moving mechanism 40 (more specifically, the scan motor 44), the transporter 50 (more specifically, the feed motor 53), the operation panel 55, the winder 70 (more specifically, the windup motor 75 and the encoder 78) and the heating device 110 (more specifically, the heater 120). The controller 80 is configured or programmed to control the ink heads 22, the head moving mechanism 40, the transporter 50, the operation panel 55, the winder 70 and the heating device 110.

The configuration of the printer 10 according to this example embodiment is described above. In this example embodiment, a windup operation, by which the winder 70 winds up the medium 5 around the windup bar 71, is as follows. When the medium 5 supported by the support table 16 is transported downstream in the sub scanning direction X by the transporter 50, the medium 5 sags on the transportation route 105 between the support table 16 and the winder 70. At this point, the windup operation is performed as follows. In a state where the transporter 50 is stopped, that is, the driving of the feed motor 53 is stopped to stop the rotation of the grit rollers 51, when the medium 5 sags on the transportation route 105, the winder 70 drives the windup motor 75 to rotate the windup bar 71. In this manner, the winder 70 winds up the medium 5 around the windup bar 71. When the medium 5 is wound up, the medium 5 is supplied with a tensile force on the transportation route 105 to become tense. When the medium 5 on the transportation route 105 becomes tense, the windup operation of the medium 5 by the winder 70 is stopped, and the driving of the transporter 50 is resumed to transport the medium 5 downstream in the sub scanning direction X.

An abnormality may occur that the medium 5 is not properly wound up around the windup bar 71 despite that it is the timing when the winder 70 is to wind up the medium 5. An abnormality may occur that the medium 5 is wound up around the windup bar 71 despite that it is not the timing when the winder 70 is to wind up the medium 5. Such an abnormality regarding the windup of the medium 5 around the windup bar 71 is referred to as a “windup abnormality”. The windup abnormality encompasses an abnormality of the winder 70 itself. The windup abnormality encompasses, for example, an abnormality that occurs by the windup bar 71 not being rotated despite that it is the timing when the medium 5 is to be wound up and an abnormality that occurs by the windup bar 71 being rotated despite that it is not the timing when the medium 5 is to be wound up.

In this example embodiment, the windup abnormality encompasses a transportation defect. The “transportation defect” refers to that the medium 5 is not properly transported. When such a transportation defect occurs, the medium 5 may not be properly wound up around the windup bar 71 even though the winder 70 itself operates normally. Herein, the “transportation defect” encompasses a situation where the medium 5 is not properly transported in the sub scanning direction X because of, for example, the medium 5 not being attached to the feeding device 60 or the medium 5 not being properly supported by the support table 16. When such a transportation defects occurs, a windup abnormality may occur due to idle rotation of the windup bar 71, that is, due to the windup bar 71 rotating without winding up the medium 5.

In this example embodiment, the controller 80 of the printer 10 is configured or programmed to automatically determine presence/absence of an windup abnormality. In this example embodiment, as shown in FIG. 4, the controller 80 is configured or programmed to include a storage 81, a windup instructor 82, a rotation detector 84, a detector 86, an abnormality determiner 88, a waiting controller 89, and a notifier 90. Each of the elements of the controller 80 may be realized by one or a plurality of processors, or may be realized by a circuit.

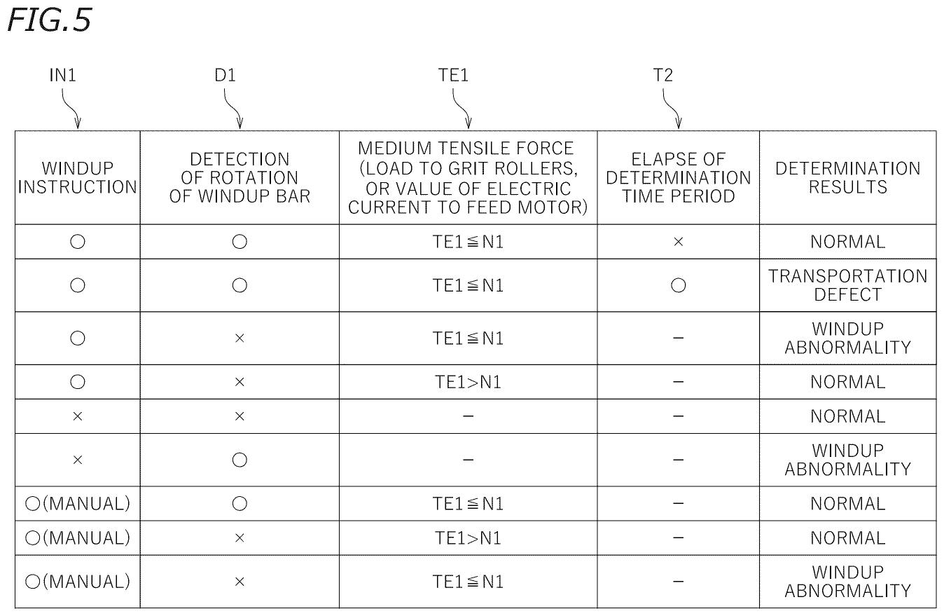

FIG. 5 is a table showing the relationship between the presence/absence of a windup abnormality and a combination of presence/absence of a windup instruction IN1, presence/absence of detection D1 of the rotation of the windup bar 71 and the magnitude of a medium tensile force TE1. In this example embodiment, as shown in FIG. 5, the presence/absence of a windup abnormality may be determined based on the presence/absence of the windup instruction IN1, the presence/absence of the detection D1 of the rotation of the windup bar 71 and the magnitude of the medium tensile force TE1 applied to the medium 5.

The “windup instruction IN1” is an instruction to perform the windup operation, and is issued to the winder 70 by the controller 80. The “windup operation” herein refers to an operation by which the windup motor 75 of the winder 70 is driven to rotate the windup bar 71, and thus to wind up the medium 5 around the windup bar 71. In this example embodiment, the windup instructor 82 shown in FIG. 4 issues the windup instruction IN1 to the winder 70. In this example embodiment, the windup instructor 82 sends a driving signal to the windup motor 75 of the winder 70 to issue the windup instruction IN1. In the winder 70, the windup motor 75 is driven at the timing when the driving signal is received, and the windup bar 71 is rotated.

There is no specific limitation on the timing when the windup instructor 82 issues the windup instruction IN1. When the controller 80 automatically determines that it is the timing to issue the windup instruction IN1, the windup instructor 82 issues the windup instruction IN1. When, for example, the medium 5 is transported by the transporter 50 downstream in the sub scanning direction X by a predetermined transportation distance during printing, the controller 80 determines that is it the timing to issue the windup instruction IN1, and the windup instructor 82 issues the windup instruction IN1 to the winder 70.

The timing to issue the windup instruction IN1 may be determined manually by the user. For example, the printer 10 is configured to allow a manual windup mode to be set. When the manual windup mode is set, a windup button (not shown) is displayed on, for example, a display screen 56 of the operation panel 55. The user operates the operation keys 57 to press the windup button. When the windup button is pressed, the windup instructor 82 issues the windup instruction IN1 to the winder 70. Note that the winder 70 itself may include an operation button or an operation lever by which the rotation of the windup bar 71 is manually instructed. In this case, at the timing when the user operates the operation button or the operation lever provided in the winder 70, the windup instructor 82 issues the windup instruction IN1. In FIG. 5, the windup instruction IN1 issued manually is represented as “◯ (manual)”.

In this example embodiment, the “presence/absence of the detection D1 of the rotation of the windup bar 71” refers to whether or not it is detected that the windup bar 71 is actually rotated. In this example embodiment, the detection D1 of the rotation of the windup bar 71 is performed by the rotation detector 84 shown in FIG. 4. The rotation detector 84 detects, by use of the encoder 78, the presence/absence of the rotation of the windup bar 71. As described above, the encoder 78 detects the rotation rate or the rotation angle of the windup bar 71 to detect the presence/absence of the rotation of the windup bar 71. In this example embodiment, the rotation detector 84, for example, sends a detection signal to the encoder 78. Upon receipt of the detection signal, the encoder 78 detects the presence/absence of the rotation of the windup bar 71 and sends the results to the controller 80. The rotation detector 84 acquires the results, sent from the encoder 78, on the presence/absence of the rotation of the windup bar 71.

In this example embodiment, the “magnitude of the medium tensile force TE1 applied to the medium 5” refers to the magnitude of the medium tensile force TE1 applied to the medium 5 on the transportation route 105 between the support table 16 and the winder 70. In this example embodiment, when the medium 5 is wound up around the windup bar 71, the medium tensile force TE1 is increased gradually. The magnitude of the medium tensile force TE1 is detected by the detector 86 shown in FIG. 4. The detector 86 detects the medium tensile force TE1 of the medium 5 on the transportation route 105 between the support table 16 and the winder 70. In this example embodiment, for example, when the medium tensile force TE1 of the medium 5 is increased gradually in a state where the rotation of the grit rollers 51 of the transporter 50 is stopped, the load applied to the grit rollers 51 increases. Therefore, the detector 86 may estimate the medium tensile force TE1 based on the load applied to the grit rollers 51 while the grit rollers 51 are stopped.

In this example embodiment, when the load applied to the grit rollers 51 increases while the grit rollers 51 are stopped, the grit rollers 51 tend to rotate in one direction. At this point, the feed motor 53 is driven to rotate the grit rollers 51 in the opposite direction in order to stop the rotation of the grit rollers 51 in the one direction. In order to drive the feed motor 53, an electric current is supplied to the feed motor 53. When the load applied to the grit rollers 51 increases, the value of the electric current supplied to the feed motor 53 increases. In this example embodiment, the detector 86 acquires the value of the electric current supplied to the feed motor 53, and estimates the load applied to the grit rollers 51 based on the acquired value of the electric current. Based on the estimated load, the detector 86 estimates the medium tensile force TE1.

In this example embodiment, the abnormality determiner 88 shown in FIG. 4 determines the presence/absence of a windup abnormality. The abnormality determiner 88 determines the presence/absence of a windup abnormality based on the presence/absence of the windup instruction IN1, the presence/absence of the detection D1 of the rotation of the windup bar 71, and the magnitude of the medium tensile force TE1 (in other words, the magnitude of the load applied to the grit rollers 51, or the value of the electric current supplied to the feed motor 53).

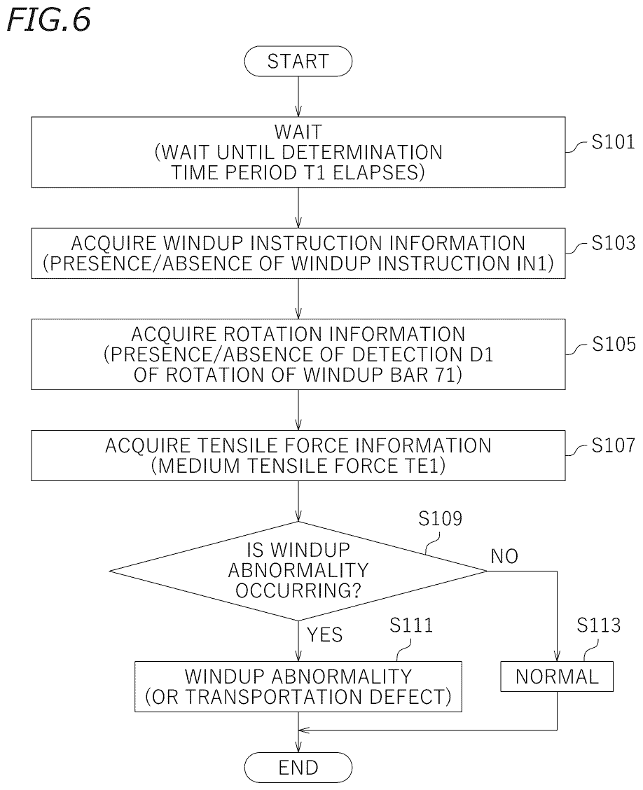

Now, the determination on the presence/absence of a windup abnormality that is made in the case where the printer 10 automatically winds up the medium 5 when the transportation of the medium 5 is started, that is, during the transportation of the medium 5, will be described based on FIG. 6, which is a flowchart.

The transportation of the medium 5 is started when, for example, printing is started. Note that immediately after the transportation of the medium 5 is started, the state of sagging of the medium 5 on the transportation route 105 is varied. That is, immediately after the transportation of the medium 5 is started, the medium 5 may sag or become tense. If the presence/absence of a windup abnormality is determined while the state of sagging of the medium 5 is varied, a wrong determination may possibly be made on the presence/absence of a windup abnormality.

Therefore, in this example embodiment, in step S101 in FIG. 6, the waiting controller 89 shown in FIG. 4 waits until a predetermined determination start time period T1 elapses after the transportation of the medium 5 supported by the support table 16 is started. That is, the determination on the presence/absence of a windup abnormality is not made immediately after the transportation of the medium 5 is started, but is started when the determination start time period T1 elapses. The windup operation is properly performed when the transportation of the medium 5 is started, even before the determination start time period T1 elapses. The “determination start time period T1” refers to a time period until which the state of sagging of the medium 5 on the transportation route 105 is stabilized to be within a predetermined range. There is no specific limitation on the length of the determination start time period T1. The length of the determination start time period T1 may be set in accordance with the model of the printer 10. The determination start time period T1 is stored in advance on the storage 81 shown in FIG. 4.

The waiting controller 89 may wait until the predetermined determination start time period T1 elapses after the windup operation of the medium 5 by the winder 70 is started. It is preferred that the determination start time period T1 is a time period until which the state of sagging of the medium 5 on the transportation route 105 is stabilized to be within a predetermined range by either one of, or both of, the transportation operation of the medium 5 by the transporter 50 and the windup operation of the medium 5 by the winder 70.

In this manner, the waiting controller 89 waits until the determination start time period T1 elapses after the transportation of the medium 5 is started. After this, the abnormality determiner 88 determines the presence/absence of a windup abnormality at every predetermined reference time interval. That is, after the determination start time period T1 elapses, the procedure of steps S103 through S113 shown in FIG. 6 is performed at

### Every Predetermined Reference Time Interval.

In this example embodiment, the determination on the presence/absence of a windup abnormality is performed as follows. In step S103 in FIG. 6, the abnormality determiner 88 shown in FIG. 4 acquires windup instruction information on whether or not the windup instruction IN1 is issued by the windup instructor 82. The windup instruction information may be acquired from, for example, the windup instructor 82. Next, in step S105 in FIG. 6, the abnormality determiner 88 shown in FIG. 4 acquires rotation information on the presence/absence of the detection D1, of the rotation of the windup bar 71, performed by the rotation detector 84. The rotation information may be acquired from, for example, the rotation detector 84. In step S107 in FIG. 6, the abnormality determiner 88 acquires tensile force information on the medium tensile force TE1 detected (or estimated) by the detector 86. The tensile force information may be acquired from, for example, the detector 86. The tensile force information may include information on the load applied to the grit rollers 51 or information on the value of the electric current supplied to the feed motor 53. There is no specific limitation on the order in which steps S103, S105 and S107 in FIG. 6 are performed.

In this manner, the windup instruction information, the rotation information and the tensile force information are acquired. After this, in step S109 in FIG. 6, the abnormality determiner 88 determines the presence/absence of a windup abnormality. In this example embodiment, when the windup instruction IN1 is issued during, for example, the windup operation, the windup bar 71 of the winder 70 is rotated. Therefore, in the case where the windup operation is performed normally, the rotation of the windup bar 71 is detected. In this example embodiment, “the windup operation” is performed when the medium tensile force TE1 of the medium 5 on the transportation route 105 is equal to, or lower than, a predetermined reference value N1 (see FIG. 5) and thus the medium 5 is sagging. The reference value N1 is stored in advance on the storage 81 shown in FIG. 4.

In this example embodiment, as shown in FIG. 5, in the case where the windup instruction IN1 is issued, the rotation of the windup bar 71 is detected, and the medium tensile force TE1 is equal to, or lower than, the reference value N1, the abnormality determiner 88 determines that there is no windup abnormality and that the windup operation is performed normally. In the case where the windup operation is performed normally, the medium 5 is wound up around the windup bar 71. Therefore, the medium tensile force TE1 is increased gradually and exceeds the reference value N1. When, for example, the medium tensile force TE1 is larger than the reference value N1, the medium 5 is tense. Therefore, even when the windup motor 75 is driven, the windup bar 71 does not rotate and the medium 5 is not wound up around the windup bar 71. For this reason, as shown in FIG. 5, in the case where the windup instruction IN1 is issued, the rotation of the windup bar 71 is not detected, and the medium tensile force TE1 is larger than the reference value N1, the abnormality determiner 88 determines that the windup operation is performed normally because the medium 5 is tense and is not in a state of being wound up.

In the case where the windup operation is performed normally, the medium 5 is wound up around the windup bar 71 before, for example, at least a predetermined determination time period T2 (see FIG. 5) elapses, so that the medium tensile force TE1 exceeds the reference value N1. By contrast, in the case where the medium tensile force TE1 is equal to, or lower than, the reference value N1 even when the determination time period T2 elapses, a defect on the transportation of the medium 5 is occurring. Therefore, it is estimated that the medium 5 is not properly wound up around the windup bar 71 even if the windup bar 71 is rotated. The “determination time period T2” refers to a time period set to be equal to, or longer than, the time for the windup operation that is required for the medium tensile force TE1 of the medium 5 to exceed the reference value N1. The determination time period T2 is appropriately set in accordance with the model of the printer 10, the rotation rate per unit time of the windup bar 71, or the like, and is stored in advance on the storage 81 shown in FIG. 4. In this example embodiment, as shown in FIG. 5, in the case where the windup instruction IN1 is issued, the rotation of the windup bar 71 is detected, and the state where the medium tensile force TE1 is equal to, or lower than, the reference value N1 is kept for the determination time period T2, the abnormality determiner 88 determines that a transportation defect is occurring.

In the case where, for example, the windup instruction IN1 is issued, the windup motor 75 is in a state of being driven. However, if an abnormality is occurring to the winder 70 (e.g., the windup motor 75, the encoder 78 or the like), a situation may occur where despite that the windup instruction IN1 is issued, the windup bar 71 is not rotated and thus the medium 5 is not wound up around the windup bar 71. Therefore, as shown in FIG. 5, in the case where the windup instruction IN1 is issued, the rotation of the windup bar 71 is not detected, and the medium tensile force TE1 is equal to, or lower than, the reference value N1, the abnormality determiner 88 determines that a windup abnormality is occurring. In the case where it is determined in step S109 in FIG. 6 that a windup abnormality encompassing a transportation defect is occurring, the procedure advances to step S111 in FIG. 6, and the abnormality determiner 88 determines that a windup abnormality encompassing a transportation defect is occurring. By contrast, in the case where it is determined in step S109 in FIG. 6 that there is no windup abnormality, the procedure advances to step S113 in FIG. 6, and the abnormality determiner 88 determines that the windup operation is performed normally.

Now, the determination on the presence/absence of a windup abnormality made while the transportation of the medium 5 is stopped and the windup operation is not performed will be described. In the case where the transportation of the medium 5 is stopped, the state of sagging of the medium 5 does not change in accordance with the time. Therefore, in this case, the control, in step S101 in FIG. 6, of waiting until the determination start time period T1 elapses is not performed. The determination on the presence/absence of a windup abnormality is started immediately. In this example embodiment, the abnormality determiner 88 acquires the windup instruction information, the rotation information and the tensile force information in steps S103, S105 and S107 in FIG. 6.

In this example embodiment, when the windup operation is not performed, the windup instruction IN1 is not issued to the winder 70. Therefore, in the case where the winder 70 is normal, the windup bar 71 is not rotated. For this reason, as shown in FIG. 5, in the case where the windup instruction IN1 is not issued and the rotation of the windup bar 71 is not detected, the abnormality determiner 88 determines that the windup operation is performed normally. By contrast, in the case where the windup bar 71 is rotated despite that the windup instruction IN1 is not issued, it is estimated that an abnormality is occurring to the winder 70 (e.g., the windup motor 75, the encoder 78 or the like). Therefore, as shown in FIG. 5, in the case where the windup instruction IN1 is not issued and the rotation of the windup bar 71 is detected, the abnormality determiner 88 determines that a windup abnormality is occurring.

While the windup operation is stopped, the magnitude of the medium tensile force TE1 is varied. Therefore, the magnitude of the medium tensile force TE1 does not need to be considered in order to determine the presence/absence of a windup abnormality in the case where the windup instruction IN1 is not issued and the windup operation is stopped. For this reason, the acquisition of the tensile force information may be omitted when the presence/absence of a windup abnormality is to be determined while the windup operation is stopped.

Now, the determination on the presence/absence of a windup abnormality made when the windup operation is performed by the user manually issuing the windup instruction IN1 will be described. In this case, the transportation of the medium 5 is stopped, and thus the state of sagging of the medium 5 does not change in accordance with the time. Therefore, in this case, the control, in step S101 in FIG. 6, of waiting until the determination start time period T1 elapses is not performed. The determination on the presence/absence of a windup abnormality is started immediately. In this example embodiment, the abnormality determiner 88 acquires the windup instruction information, the rotation information and the tensile force information in steps S103, S105 and S107 in FIG. 6.

When the windup instruction IN1 is manually issued and the windup operation is started, the windup bar 71 of the winder 70 is rotated. Therefore, in the case where the windup operation is performed normally, the rotation of the windup bar 71 is detected. In this example embodiment, “the windup operation” is performed when the medium tensile force TE1 of the medium 5 on the transportation route 105 is equal to, or lower than, the reference value N1 and the medium 5 is sagging. Therefore, as shown in FIG. 5, in the case where the windup instruction IN1 is manually issued, the rotation of the windup bar 71 is detected, and the medium tensile force TE1 is equal to, or lower than, the reference value N1, the abnormality determiner 88 determines that there is no windup abnormality and that the windup operation is performed normally.

In the case where as described above, when the medium tensile force TE1 is larger than the reference value N1, the medium 5 is tense on the transportation route 105. Therefore, even if the windup motor 75 is driven, the windup bar 71 does not rotate. Therefore, as shown in FIG. 5, in the case where the windup instruction IN1 is manually issued, the rotation of the windup bar 71 is not detected, and the medium tensile force TE1 is larger than the reference value N1, the abnormality determiner 88 determines that the windup operation is performed normally because the medium 5 is tense and is not in a state of being wound up.

By contrast, when an abnormality is occurring to the winder 70 (e.g., the windup motor 75, the encoder 78 or the like), the windup bar 71 is not rotated and thus the medium 5 is not wound up around the windup bar 71 despite that the windup instruction IN1 is manually issued. Therefore, as shown in FIG. 5, in the case where the windup instruction IN1 is manually issued, the rotation of the windup bar 71 is not detected, and the medium tensile force TE1 is equal to, or lower than, the reference value N1, the abnormality determiner 88 determines that a windup abnormality is occurring.

The determination on the presence/absence of a windup abnormality is performed in the manner described above. The results of the determination on the presence/absence of a windup abnormality may be notified to the user. In this example embodiment, when the abnormality determiner 88 determines that a windup abnormality is occurring, the notifier 90 shown in FIG. 4 may notify the user of such results. There is no specific limitation on the method for notifying the user of the windup abnormality. For example, the notifier 90 displays a message indicating that a windup abnormality is occurring on the display screen 56 (see FIG. 1) of the operation panel 55 to notify the user of the windup abnormality. The addressee of the notification of the windup abnormality is not limited to the display screen 56, and may be, for example, an operation terminal that is connected with the printer 10 and, for example, issues a printing instruction to the printer 10. The operation terminal may be a personal computer on which a driver instructing the printer 10 to print is installed.

As described above, in this example embodiment, as shown in FIG. 2, the printer 10 includes the support table 16 to support the medium 5, the transporter 50 to transport the medium 5 supported by the support table 16 in the sub scanning direction X, the winder 70 to wind up the medium 5 transported downstream with respect to the support table 16 in the sub scanning direction X, and the controller 80 (see FIG. 1). The winder 70 includes the windup bar 71 having the medium 5 wound around the circumferential surface thereof, the windup motor 75 to rotate the windup bar 71 around the central axis A2 of the windup bar 71, and the encoder 78 to detect the rotation of the windup bar 71. As shown in FIG. 4, the controller 80 is configured or programmed to include the windup instructor 82, the rotation detector 84, the detector 86, and the abnormality determiner 88. The windup instructor 82 is configured or programmed to issue the windup instruction IN1 to rotate the windup bar 71 and wind up the medium 5 around the windup bar 71. The rotation detector 84 is configured or programmed to detect the presence/absence of the rotation of the windup bar 71 by use of the encoder 78. The detector 86 is configured or programmed to detect the medium tensile force TE1 of the medium 5 between the support table 16 and the winder 70. The abnormality determiner 88 is configured or programmed to determine the presence/absence of a windup abnormality while the medium 5 is wound up around the windup bar 71. The abnormality determiner 88 is configured or programmed to determine the presence/absence of a windup abnormality based on the presence/absence of the windup instruction IN1 issued by the windup instructor 82, the presence/absence of the rotation, of the windup bar 71, detected by the rotation detector 84, and the magnitude of the medium tensile force TE1 detected by the detector 86. For example, when the windup instruction IN1 is issued in the case where the winder 70 is normal, the windup bar 71 is rotated to gradually increase the medium tensile force TE1. Then, the rotation of the windup bar 71 is stopped. If, for example, the windup instruction IN1 is not issued in the case where the winder 70 is normal, the windup bar 71 is not rotated. Therefore, the presence/absence of a windup abnormality may be determined based on the presence/absence of the rotation of the windup bar 71 and the magnitude of the medium tensile force TE1 in accordance with the presence/absence of the windup instruction IN1.

In this example embodiment, as shown in FIG. 5, in the case where the windup instruction IN1 is issued by the windup instructor 82, the rotation of the windup bar 71 is not detected by the rotation detector 84, and the medium tensile force TE1 detected by the detector 86 is equal to, or lower than, the reference value N1, the abnormality determiner 88 determines that a windup abnormality is occurring. In the case where, for example, the winder 70 is normal, when the medium tensile force TE1 is equal to, or lower than, the reference value N1 and thus the medium 5 is sagging, the windup instruction IN1 is issued and the windup bar 71 is rotated. As a result of the windup bar 71 being rotated, the medium 5 is wound up around the windup bar 71. However, when a windup abnormality is occurring, the windup bar 71 is not rotated despite that the windup instruction IN1 is issued. As a result, even in the case where the medium tensile force TE1 is equal to, or lower than, the reference value N1 and thus the medium 5 is sagging, the medium 5 is not wound up around the windup bar 71. Based on the above, in the case where the windup instruction IN1 is issued, the rotation of the windup bar 71 is not detected, and the medium tensile force TE1 is equal to, or lower than, the reference value N1, it may be determined that a windup abnormality is occurring because the medium 5 is not wound up despite that the windup instruction IN1 is issued.

In this example embodiment, as shown in FIG. 5, in the case where the windup instruction IN1 is not issued by the windup instructor 82 and the rotation of the windup bar 71 is detected by the rotation detector 84, the abnormality determiner 88 determines that a windup abnormality is occurring. In the case where, for example, the winder 70 is normal, when the windup instruction IN1 is not issued, the windup motor 75 is not driven and thus the windup bar 71 is not rotated. However, in the case where a windup abnormality is occurring, the windup bar 71 may be rotated despite the windup instruction IN1 not being issued. Therefore, the presence/absence of the detection D1 of the rotation of the windup bar 71 is detected in a state where the windup instruction IN1 is not issued, so that the presence/absence of a windup abnormality may be determined.

In this example embodiment, as shown in FIG. 4, the controller 80 is configured or programmed to include the waiting controller 89. In step S101 in FIG. 6, the waiting controller 89 is configured or programmed to wait until the predetermined determination start time period T1 elapses after the transportation of the medium 5 supported by the support table 16 is started or after the windup of the medium 5 transported downstream with respect to the support table 16 in the sub scanning direction X is started. After the waiting controller 89 waits until the determination start time period T1 elapses, the abnormality determiner 88 is configured or programmed to start the determination on the presence/absence of a windup abnormality. For example, immediately after the transportation or the windup of the medium 5 is started, the state of sagging of the medium 5 is varied. If the presence/absence of a windup abnormality is determined while the state of sagging of the medium 5 is varied, a wrong determination may possibly be made. Therefore, in this example embodiment, the determination on the presence/absence of a windup abnormality is started when the determination start time period T1 elapses after the transportation or the windup of the medium 5 is started, so that a wrong determination may be unlikely to be made.

In this example embodiment, as shown in FIG. 5, in the case where the windup instruction IN1 is issued by the windup instructor 82, the rotation of the windup bar 71 is detected by the rotation detector 84, and the state where the medium tensile force TE1 detected by the detector 86 is equal to, or lower than, the reference value N1 is kept for the determination time period T2, the abnormality determiner 88 determines that a transportation defect of the medium 5 is occurring. For example, when the windup instruction IN1 is issued and the medium 5 is wound up, the medium tensile force TE1 is gradually increased, and exceeds the reference value N1 before the determination time period T2 elapses. By contrast, if a transportation defect is occurring, the medium 5 is not wound up and the medium tensile force TE1 does not exceed the reference value N1 despite that the windup bar 71 is rotated. Therefore, it is determined whether or not the state where the medium tensile force TE1 is equal to, or lower than, the reference value N1 is kept for the determination time period T2 or longer in the case where the windup instruction IN1 is issued, so that it may be determined whether or not a transportation defect, as a type of windup abnormality, is occurring.

In this example embodiment, as shown in FIG. 2, the transporter 50 includes the grit rollers 51 contacting the medium 5 and the feed motor 53 rotating the grit rollers 51. The detector 86 shown in FIG. 4 estimates the medium tensile force TE1 based on the load applied to the grit rollers 51 while the grit rollers 51 are stopped. For example, when the medium tensile force TE1 is increased, the grit rollers 51 are pulled by the medium 5. As a result, the load applied to the grit rollers 51 is increased. Therefore, the medium tensile force TE1 and the load applied to the grit rollers 51 may be considered to be in proportion to each other. Thus, the load applied to the grit rollers 51 is detected, so that the medium tensile force TE1 may be estimated from the load.

In this example embodiment, the detector 86 is configured or programmed to estimate the load applied to the grit rollers 51 based on the value of the electric current supplied to the feed motor 53. In this example embodiment, when the medium tensile force TE1 is increased and thus the load applied to the grit rollers 51 is increased, the grit rollers 51 tend to rotate in one direction. At this point, the feed motor 53 is driven to rotate the grit rollers 51 in the opposite direction in order to stop the rotation of the grit rollers 51 in the one direction. In order to drive the feed motor 53, an electric current is supplied to the feed motor 53. When the load applied to the grit rollers 51 increases, the value of the electric current supplied to the feed motor 53 increases. Therefore, the magnitude of the load applied to the grit rollers 51 and the magnitude of the electric current supplied to the feed motor 53 may be considered to be in proportion to each other. Thus, the value of the electric current supplied to the feed motor 53 is acquired, so that the load applied to the grit rollers 51 may be estimated from the value of the electric current. From the estimated load, the medium tensile force TE1 may be estimated.

In this example embodiment, the medium tensile force TE1 is estimated based on the value of the electric current supplied to the feed motor 53. Alternatively, the printer 10 may be configured such that the medium tensile force TE1 is directly detected. In this case, the printer 10 may include, for example, a tensile force sensor detecting the medium tensile force TE1 of the medium 5 on the transportation route 105. In this case, the detector 86 may acquire the medium tensile force TE1 from the tensile force sensor.

The printer 10 may be configured such that the load applied to the grit rollers 51 is directly detected and the medium tensile force TE1 is estimated from the detected load. In this case, the printer 10 may include, for example, a load sensor detecting the load applied to the grit rollers 51. In this case, the detector 86 may acquire the magnitude of the load applied to the grit rollers 51 from the load sensor, and estimate the medium tensile force TE1 from the load.

In this example embodiment, the medium 5 is bulged by being heated. The medium 5 is not limited to such a medium bulged by being heated. The medium 5 may be paper such as roll-type plain paper, inkjet printing paper or the like; a sheet or a film of a resin such as polyvinylchloride, polyester or the like; or cloth such as woven cloth, unwoven cloth or the like. In the case where the medium 5 is a medium other than the medium bulged by being heated, the printer 10 may not need to include the foaming-suppressing ink head 22A or the heating device 110.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing example embodiments of the principles of the present invention. These example embodiments are provided with the understanding that they are not intended to limit the present invention to the example embodiments described in the specification and/or shown in the drawings. The present invention encompasses any of example embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the example embodiments described in this specification or referred to during the prosecution of the present application.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer, comprising:
a support table to support a medium;
a transporter to transport the medium supported by the support table in a transportation direction;
a winder to wind up the medium transported downstream with respect to the support table in the transportation direction; and
a controller; wherein
the winder includes:
a windup bar to wind the medium around a circumferential surface thereof;
a windup motor to rotate the windup bar around a central axis of the windup bar; and
an encoder to detect rotation of the windup bar;
the controller is configured or programmed to include:
a windup instructor configured or programmed to issue a windup instruction to rotate the windup bar and wind up the medium around the windup bar;
a rotation detector configured or programmed to detect presence/absence of the rotation of the windup bar by use of the encoder;
a detector configured or programmed to detect a medium tensile force of the medium between the support table and the winder; and
an abnormality determiner configured or programmed to determine presence/absence of a windup abnormality while the medium is wound up around the windup bar; and
the abnormality determiner is configured or programmed to determine the presence/absence of the windup abnormality based on presence/absence of the windup instruction by the windup instructor, the presence/absence of the rotation, of the windup bar, detected by the rotation detector, and a magnitude of the medium tensile force detected by the detector.

2. The printer according to claim 1, wherein in a case where the windup instruction is issued by the windup instructor, the rotation of the windup bar is not detected by the rotation detector, and the medium tensile force detected by the detector is equal to, or lower than, a reference value, the abnormality determiner is configured or programmed to determine that the windup abnormality is occurring.

3. The printer according to claim 1, wherein in a case where the windup instruction is not issued by the windup instructor and the rotation of the windup bar is detected by the rotation detector, the abnormality determiner is configured or programmed to determine that the windup abnormality is occurring.

4. The printer according to claim 1, wherein
the controller is configured or programmed to include a waiting controller configured or programmed to wait until a predetermined determination start time period elapses after the transportation of the medium supported by the support table is started or after the windup of the medium transported downstream with respect to the support table in the transportation direction is started; and
after the waiting controller waits until the determination start time period elapses, the abnormality determiner is configured or programmed to start determination on the presence/absence of the windup abnormality.

5. The printer according to claim 1, wherein in a case where the windup instruction is issued by the windup instructor, the rotation of the windup bar is detected by the rotation detector, and a state where the medium tensile force detected by the detector is equal to, or lower than a reference value is kept for a predetermined determination time period, the abnormality determiner is configured or programmed to determine that a transportation defect of the medium is occurring.

6. The printer according to claim 1, wherein
the transporter includes:
a grit roller to contact the medium; and
a feed motor to rotate the grit roller; and
the detector is configured or programmed to estimate the medium tensile force based on a load applied to the grit roller while the grit roller is stopped.

7. The printer according to claim 6, wherein the detector is configured or programmed to estimate the load applied to the grit roller based on a value of an electric current supplied to the feed motor.
